(19) United States
(12) Patent Application Publication
(10) Pub. No.: US 2017/0204794 A1
(43) Pub. Date: Jul. 20, 2017

(54) METHOD AND SYSTEM FOR CONTROL OF A FORCED INDUCTION SYSTEM

(71) Applicant: Scania CV AB, Södertälje (SE)

(72) Inventor: Svante LEJON, Huddinge (SE)

(21) Appl. No.: 15/302,059

(22) PCT Filed: Apr. 27, 2015
(86) PCT No.: PCT/SE2015/050467

§ 371 Date: Oct. 5, 2016

(30) Foreign Application Priority Data
Apr. 29, 2014 (SE) 1450504-4

(51) Int. Cl. F02D 23/02; F02D 41/00; F02B 37/12; F02D 41/26; F02B 37/007; F02B 37/00

(52) U.S. Cl. CPC F02D 23/02; F02B 37/007; F02B 37/001; F02B 37/12; F02D 41/26; F02D 41/0007; F02D 41/0085; F02B 2037/122

(57) ABSTRACT

In a method for the control of a supercharge system with several turbine wheels, each of which is arranged in an exhaust conduit from cylinders in a combustion engine, different from the cylinders in whose exhaust conduits the one or several other turbine wheels are arranged, wherein the turbine wheels are arranged to each operate a compressor wheel, arranged in an air inlet conduit to the combustion engine, a value for the rotational speed of the respective turbine wheels is determined, and the rotational speed of the respective turbine wheels is controlled by way of impacting the fuel injection into those cylinders, whose exhaust conduit is connected with the turbine wheel.

### CROSS-REFERENCE TO RELATED APPLICATION(S)

This application is a national stage application (filed under 35 §U.S.C. 371) of PCT/SE15/050467, filed Apr. 27, 2015 of the same title, which, in turn claims priority to Swedish Application No. 1450504-4, filed Apr. 29, 2014 of the same title; the contents of each of which are hereby incorporated by reference.

### FIELD OF THE INVENTION

The present invention relates to a method for control of a supercharge system associated with a combustion engine.

### BACKGROUND OF THE INVENTION

The invention is not limited to any specific type of combustion engine, but encompasses otto engines as well as compression ignited engines, nor to any specific fuel, non-exhaustive examples of which may comprise fuel in the form of petrol, ethanol and diesel.

Likewise, the invention comprises combustion engines intended for all types of use, such as in industrial applications, in crushing machines and various types of motor vehicles, both wheeled motor vehicles such as trucks and buses, and boats and other means of transport, such as crawler road vehicles.

In such a supercharge system with several turbine wheels, it is usually desirable to allocate the workload evenly over the turbine wheels and the compressors with compressor wheels which belong to the respective turbine wheels. If the turbine wheels may not be harmonized to similar operating rotational speeds, then features such as torque and output in the combustion engine must be slowed down. For this reason, in the method above, a value of the rotational speed of the respective turbine wheels is determined, and the speed of the turbine wheels is controlled depending on the appearance of the determined rotational speed. The concept of determining a value for a speed should be interpreted very widely. Such determination may be by way of direct measurement of the rotational speed of the blades of the relevant wheels, by for example an electric sensor detecting the passage of a mechanic element, or by indirect measurement through detecting the pressure, temperature and/or flow of the gases that pass through the wheels. The definition also comprises a definition of a rotational speed with the help of statically in-built deviations of the combustion engine's parts, associated with different exhaust conduits.

In prior art methods of the type defined above, the rotational speed of the turbine wheels is controlled by controlling the flow of exhausts, such as by way of throttles (by-pass flows), to the respective turbine wheels and/or by controlling the operation of the turbine wheel, such as by designing the turbine wheel with variable geometry (VGT=Variable Geometry Turbine) and varying the geometry of the turbine wheel.

One disadvantage of this manner of controlling said rotational speed is that the components used for this control become relatively costly, especially if the relevant combustion engine will be used in marine applications, where the classification requirements relating to the surface temperature relating of these components may entail requirements of a costly encapsulation of the components.

### SUMMARY OF THE INVENTION

The objective of the present invention is to provide a method and a system of the type defined above, which are improved in at least some respect in relation to prior art methods and systems of this type.

By carrying out the control of the rotational speed of the respective turbine wheels through impacting the fuel injection into the cylinders, whose exhaust conduit is connected with the turbine wheel, no additional components are needed to provide for the possibility of separate control of the rotational speed of the respective turbine wheels, so that accordingly a considerable cost saving may be achieved in relation to the requirements posed by prior art methods on components, in order to be able to separately control the speed of the different turbine wheels. As mentioned above, this is of particular advantage in cases where the relevant combustion engine is to be arranged where there are stringent classification requirements, relating to the outer temperature of its component parts.

According to one embodiment of the invention, the method comprises the step of comparing said determined values for the rotational speed of the turbine wheels with set-point values for these, and to impact said fuel injection into the cylinders based on the result of this comparison.

According to another embodiment of the invention, the fuel injection into the cylinders associated with the respective turbine wheels is impacted, in order to control the rotational speed of the turbine wheels towards a set-point value, in the form of an optimal operating speed for the compressor wheel connected with the turbine wheel. This does not necessarily need to be the same rotational speed, towards which the different turbine wheels are controlled, but there could also be an integrated error in the combustion engine, a so-called engine deviation, for which the control compensates.

According to another embodiment of the invention, the fuel injection into the cylinders associated with the respective turbine wheels is impacted, in order to control the rotational speed of the turbine wheel towards a working speed of the associated compressor wheel, which is located at a predetermined distance from, or within a predetermined distance interval, from the pumping limit of the compressor wheel. In the absence of a separate control of the rotational speed of the respective turbine wheels, it is normally necessary for the compressor wheels to have a speed which is at least 20% lower than the speed of the compressor wheels' pumping limit, i.e. the speed at which the compressor wheel begins to pump back gases in the wrong direction. By instead controlling the rotational speed of the individual turbine wheels separately, it becomes possible to come closer to said pumping limit with a sufficient margin for unusual operating modes without pumping arising. One advantage of coming closer to said pumping limit, is that it is then possible to achieve a combination of high output at high speeds and of high torque at lower speeds in the combustion engine, since the supercharge system does not need to be designed with as large a margin towards pumping, but may be dimensioned with more focus on the engine's maximum output.

According to another embodiment of the invention, the fuel injection into the cylinders is impacted, on order to balance the workload/speed of the different turbine wheels with each other. Accordingly, the impact of fuel injection into the cylinders may take place to control the rotational speed of the turbine wheels towards one and the same value, which makes it possible to come closer to said pumping limit, and/or closer to the maximum permitted turbine speed for all turbines comprised in the system.

According to another embodiment of the invention, the control of the speed of the respective turbine wheels is carried out by controlling the amount of fuel injected into the cylinders associated with the turbine wheel. For example, the amount of fuel injected into the cylinders associated with the slowest turbine wheel may be increased, in order to increase the speed of the turbine wheel.

According to another embodiment of the invention, the method comprises control of the rotational speed of the respective turbine wheels by way of controlling post-injections of fuel into cylinders associated with the turbine wheel, i.e. fuel injection following the combustion occurring in the respective cylinders, with the objective of impacting the piston of the cylinder, in order to impact the pressure of exhaust pulses and the temperature of exhausts from the cylinder. This constitutes another simple manner of achieving said control by way of impact of fuel injection on.

According to another embodiment of the invention, the method comprises control of the rotational speed of the respective turbine wheels by controlling the timing of fuel injection into the cylinders associated with the turbine wheel. This approach is commonly referred to as phasing, wherein, by moving the position of injections into different cylinders, uneven gaps are achieved between the exhaust pulses from these. For example, injection could occur in one cylinder at a crankshaft angle of 8° and in another, in a crankshaft angle of 12°, in order thus to impact the appearance of the exhaust pulses.

Other advantageous features and advantages of the invention are set out in the description below.

### BRIEF DESCRIPTION OF THE DRAWINGS

Below are descriptions of example embodiments of the invention, with reference to the enclosed drawings, in which:

FIG. 1 is a schematic view, illustrating a system for control of a supercharge system in a combustion engine according to one embodiment of the invention,

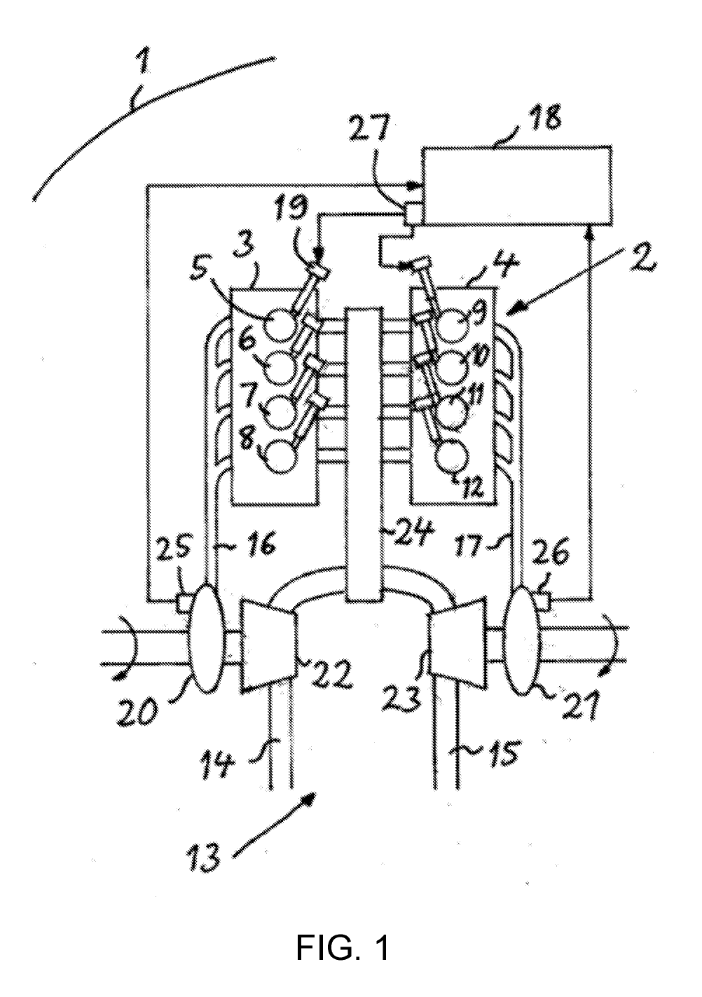

FIG. 2 is a flow chart showing a method according to one embodiment of the invention, and

FIG. 3 is a diagram of an electronic control device for the implementation of a method according to the invention.

### DETAILED DESCRIPTION OF AN EMBODIMENT ACCORDING TO THE INVENTION

The invention will be described below as applied in a motor vehicle 1. The invention is not, however, limited to this application. The motor vehicle has a combustion engine 2, with two cylinder groups 3, 4 for every four cylinders 5-12. Air is supplied to the cylinders of the combustion engine via an air inlet conduit 13, which, at the very end of the air inlet is divided into two sections 14, 15. Exhausts are led away from the combustion engine via an exhaust pipe 16, 17, connected to each group of cylinders.

The vehicle's electronic control device 18 is schematically indicated, and adapted to e.g. control fuel injection into the engine's cylinders, which is indicated by arrows pointing towards schematically displayed injection nozzles 19.

The combustion engine is equipped with a turbo charger having two turbine wheels 20, 21, which are arranged in each of the exhaust conduits 16, 17 from both cylinder groups 3, 4. The turbine wheels are arranged to operate a compressor wheel 22, 23 each, each arranged in its own section 14, 15 of the air inlet conduit 13, in order to generate a desired charge air pressure supplied to the cylinders of the combustion engine downstream of the compressor wheels 22, 23, via the exhaust conduit section 24.

Means 25, 26 are arranged to measure the rotational speed of the respective turbine wheels and to send information regarding this to the electronic control device 18. This device 18 is adapted to process such information and subsequently provide a device 27—schematically drawn—with a command to control the speed of the respective turbine wheels 20, 21 by impacting the fuel injection into those cylinders, whose exhaust conduit 16, 17 is connected with the relevant turbine wheel. Such impact on the fuel injection may for example occur through variation of the amount of fuel injected, so that, for example, more fuel is injected into cylinders associated with a turbine wheel that has a lower rotational speed, than what is the case for the second turbine wheel, and accordingly the pulse content appearance of the exhaust flow in this exhaust conduit may be altered, so that the rotational speed of the turbine wheel increases. Another possibility is to carry out post-injections of fuel into the cylinders associated with a turbine wheel, in order thus to increase the rotational speed of the turbine wheel. It is also possible to vary the crankshaft angle at which fuel injection occurs in the different cylinders, so that the injection occurs, for example, at an angle of 8° in one cylinder and at 12° in another, in order to impact the appearance of the exhaust pulses from the cylinders. The invention is not limited, however, to these manners of impacting the fuel injection into the cylinders, but covers every possible such impact.

Since the system may in this manner control the rotational speed of the respective turbine wheels separately from the control of the rotational speed of the second turbine wheel, it may e.g. be ensured that the speed of the turbine wheels is always equally high, if desirable, which means there is a possibility of operating the compressor wheels very close to their pumping limit without any risk of pumping arising. Accordingly, a combination of a high output at high speeds and of a good torque at lower speeds of the compressor wheels is achieved. However, it is also conceivable that, for some reason, the pumping limit is not the same in the various compressor parts, and that a certain distance between the rotational speeds of both compressor wheels is desired. about the desire to compensate for an existing engine deviation may also be a reason to control the turbine wheels, and accordingly the compressor wheels, towards different rotational speeds, or to the same speed if this improves the engine characteristics, and if there is an inbuilt static engine deviation, then it also is not absolutely necessary to measure the rotational speed of the turbines, but the constitution of the injections may be controlled towards expected static differences.

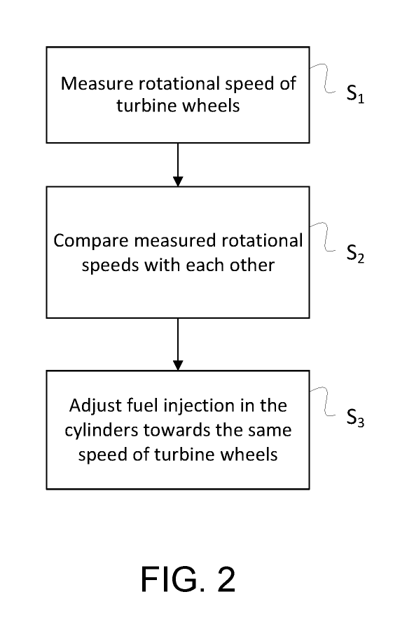

FIG. 2 shows a flow chart illustrating an embodiment of a method according to the present invention, for the control of a flow of a turbo charger of the type described above. In a first step S₁ the rotational speed of each turbine wheel is measured. Subsequently, in a second step S₂, the measured speeds are compared with each other, following which, in a third step, S₃, the fuel injection into the cylinders is controlled towards the same rotational speed of the turbine wheels. As mentioned above, in a method according to the invention, said control may occur with a number of other objectives than the one mentioned here.

A computer program code for the implementation of a method according to the invention is suitably included in a computer program, loadable into the internal memory of a computer, such as the internal memory of an electronic control device of a combustion engine. Such a computer program is suitably provided via a computer program product, comprising a data storage medium readable by an electronic control device, which data storage medium has the computer program stored thereon. Said data storage medium is e.g. an optical data storage medium in the form of a CD-ROM, a DVD, etc., a magnetic data storage medium in the form of a hard disk drive, a diskette, a cassette, etc., or a Flash memory or a ROM, PROM, EPROM or EEPROM type memory.

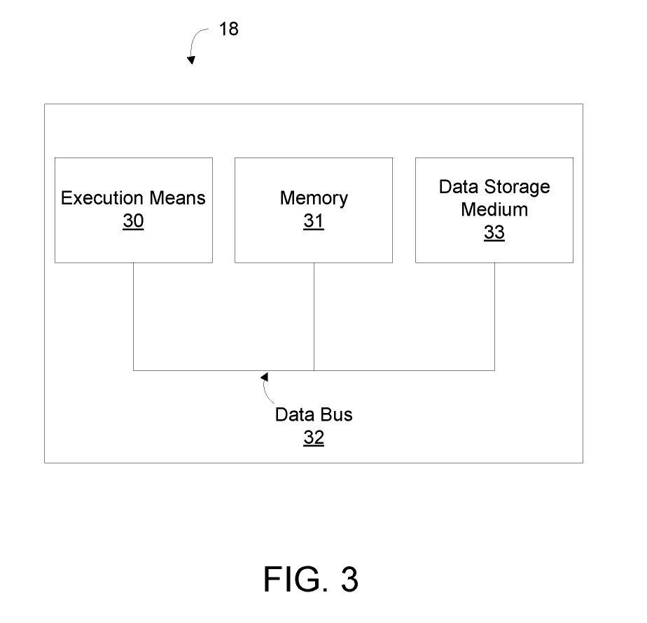

FIG. 3 very schematically illustrates an electronic control device 18, comprising execution means 30, such as a central processor unit (CPU), for the execution of computer software. The execution means 30 communicates with a memory 31, e.g. a RAM memory, via a data bus 32. The control device 18 also comprises a data storage medium 33, e.g. in the form of a Flash memory or a ROM, PROM, EPROM or EEPROM type memory. The execution means 30 communicates with the data storage means 33 via the data bus 32. A computer program comprising computer program code for the implementation of a method according to the invention is stored on the data storage medium 33.

The invention is obviously not limited in any way to the embodiments described above, but numerous possible modifications thereof should be obvious to a person skilled in the area, without such person departing from the spirit of the invention as defined by the appended claims.

The number of turbine wheels and compressor wheels operated by these may be different, i.e. greater, than displayed.

1. A method for control of a supercharge system with a number of turbine wheels, each of which is arranged in an exhaust conduit, from cylinders in a combustion engine, different from the cylinders in whose exhaust conduits the one or several other turbine wheels are arranged, wherein the turbine wheels are arranged to each operate a compressor wheel, arranged in an air inlet conduit to the combustion engine, wherein the method comprises the steps of:
determining a value for the rotational speed of the respective turbine wheels; and
controlling the rotational speed of the respective turbine wheels depending on said determined speed, by impacting the fuel injection into those cylinders, whose exhaust conduit is connected with a respective turbine wheel.

2. A method according to claim 1 further comprising comparing said determined values for the rotational speed of the turbine wheels with set-point values for these, and said controlling the rotational speed comprises impacting said fuel injection into the cylinders based on the result of such comparison.

3. A method according to claim 2, wherein impacting the fuel injection comprises impacting the fuel injection into the cylinders associated with the respective turbine wheels to control the rotational speed of the turbine wheel towards a set-point value in the form of an optimal working speed for the compressor wheel, connected with the turbine wheel.

4. A method according to claim 2, wherein impacting the fuel injection comprises impacting the fuel injection into the cylinders associated with the respective turbine wheels to control the rotational speed of the turbine wheel towards a working speed of the associated compressor wheels, located at a predetermined distance from the rotational speed of the compressor wheels' pumping limit, or within a predetermined distance interval from the rotational speed of the compressor wheels' pumping limit.

5. A method according to claim 1, wherein impacting the fuel injection comprises impacting the fuel injection into the cylinders to balance the workload/speed of the various turbine wheels with each other.

6. A method according to claim 1, wherein impacting the fuel injection comprises impacting the fuel injection into the cylinders for control of the rotational speed of the turbine wheels towards one and the same value.

7. A method according to claim 1, wherein the control of the rotational speed of the respective turbine wheels is carried out by controlling the amount of fuel injected into the cylinders associated with the turbine wheel.

8. A method according to claim 1 comprising control of the rotational speed of the respective turbine wheels by controlling post-injections of fuel into cylinders associated with the turbine wheel following the combustion occurring in the respective cylinder, with the objective of impacting the cylinder's piston, in order to impact the pressure of exhaust pulses and the temperature of exhausts from the cylinder.

9. A method according to claim 1 comprising control of the rotational speed of the respective turbine wheels by controlling the timing of fuel injections into the cylinders associated with the turbine wheel.

10. A system for control of a supercharge system with several turbine wheels, each of which is arranged in an exhaust conduit from cylinders in a combustion engine, different from the cylinders in whose exhaust conduits the one or several other turbine wheels are arranged, wherein the turbine wheels are arranged to each operate one compressor wheel, arranged in an air inlet conduit to the combustion engine, said system comprising:
means adapted to determine a value of the rotational speed in the respective turbine wheels; and
a device adapted to control the rotational speed of the turbine wheels depending on information from said means about speed values determined thereby, wherein that the device is adapted to control the speed of the respective turbine wheels by impacting the fuel injection into those cylinders, whose exhaust conduit is connected with a respective turbine wheel.

11. A system according to claim 10 further comprising, a device adapted to compare determined rotational speed values for the turbine wheels with set-point values for these, and to control the device to carry out said control based on the result of such comparison.

12. (canceled)

13. A computer program product comprising computer program code stored on a non-transitory computer-readable medium, which is readable by a computer, said computer program product used for control of a supercharge system with several turbine wheels, each of which is arranged in an exhaust conduit from cylinders in a combustion engine, different from the cylinders in whose exhaust conduits the one or several other turbine wheels are arranged, wherein the turbine wheels are arranged to each operate one compressor wheel, arranged in an air inlet conduit to the combustion engine, said computer program code comprising computer instructions to cause one or more computer processors to perform the operations of:
determining a value for the rotational speed of the respective turbine wheels; and
controlling the rotational speed of the respective turbine wheels depending on said determined speed, by impacting the fuel injection into those cylinders, whose exhaust conduit is connected with a respective turbine wheel.

14. An electronic control device for control of a supercharge system with several turbine wheels, each of which is arranged in an exhaust conduit from cylinders in a combustion engine, different from the cylinders in whose exhaust conduits the one or several other turbine wheels are arranged, wherein the turbine wheels are arranged to each operate one compressor wheel, arranged in an air inlet conduit to the combustion engine, said electronic control device comprising: comprising:
one or more computer processors;
a non-transitory computer-readable medium;
a computer program product comprising computer program code stored on the non-transitory computer-readable medium, said computer program code comprising computer instructions to cause the one or more computer processors to perform the operations of:
determining a value for the rotational speed of the respective turbine wheels; and
controlling the rotational speed of the respective turbine wheels depending on said determined speed, by impacting the fuel injection into those cylinders, whose exhaust conduit is connected with a respective turbine wheel.

15. A motor vehicle comprising:
a combustion engine;
a supercharge system with several turbine wheels, each of which is arranged in an exhaust conduit from cylinders in the combustion engine, different from the cylinders in whose exhaust conduits the one or several other turbine wheels are arranged, wherein the turbine wheels are arranged to each operate one compressor wheel, arranged in an air inlet conduit to the combustion engine;
means adapted to determine a value of the rotational speed in the respective turbine wheels; and
a device adapted to control the rotational speed of the turbine wheels depending on information from said means about speed values determined thereby, wherein the device is adapted to control the speed of the respective turbine wheels by impacting the fuel injection into those cylinders, whose exhaust conduit is connected with a respective turbine wheel.

16. A motor vehicle according to claim 15, wherein it is a wheeled motor vehicle, such as a truck or a bus, or a boat.
